(19) United States
(12) Patent Application Publication
(10) Pub. No.: US 2015/0369176 A1
(43) Pub. Date: Dec. 24, 2015

(54) VALVE FOR METERING FLUID, THE VALVE CONTAINING A FILTER DEVICE

(71) Applicant: ROBERT BOSCH GMBH, Stuttgart (DE)

(72) Inventors: Ralph Ittlinger, Weissach (DE); Martin Scheffel, Vaihingen (DE); Jens Pohlmann, Bietigheim-Bissingen (DE)

(21) Appl. No.: 14/765,617

(22) PCT Filed: Jan. 17, 2014
(86) PCT No.: PCT/EP2014/050863

§ 371 Date: Aug. 4, 2015

(30) Foreign Application Priority Data
Feb. 6, 2013 (DE) 10 2013 201 897.5

(51) Int. Cl. F02M 21/02; F02M 63/00; B01D 35/30; F02M 37/22; B01D 46/00; B01D 29/56

(52) U.S. Cl. CPC F02M 21/0227; B01D 46/0002; B01D 46/0023; B01D 29/56; B01D 35/30; F02M 37/22; F02M 63/007

(57) ABSTRACT

A valve for metering fluid includes: a flow channel, which leads from a fluid inlet to a metering opening for the fluid; and a filter device, which is situated in the flow channel, and through which the fluid flows. The filter device has a coarse filter and a fine filter which is situated downstream from the coarse filter in the flow direction of the fluid.

### BACKGROUND OF THE INVENTION

1. Field of the Invention

The present invention is directed to a valve for metering fluid, the use of the superordinate term fluid representing a streaming or flowing medium consistent with the fluid mechanics for gases and liquids.

2. Description of the Related Art

A known fuel injector (published German patent application document DE 10 2005 061 424 A1) has a connecting piece including an inflow channel for the fuel, which continues in a flow channel for the fuel extending through a hollow magnet core of a solenoid and through a hollow valve needle including a closing head for controlling a metering opening. In order to filter out foreign particles in the fuel which, due to their size, are able to cause clogging or damage in the injector, a filter device is inserted into the inflow channel of the connecting piece. The filter device has a filter pot including a pot bottom, through which the fluid is unable to flow, and a filter structure situated in the pot casing area, such as filter fabric, grid or screen. In the area of the pot opening, the filter pot is enclosed by a radially projecting annular shoulder which is in close contact with the channel wall of the inflow channel. The fuel enters into the filter pot axially and exits the filter pot again radially through the filter structure in the pot casing area.

In the case of such fuel injectors, it has been shown that larger single particles, which primarily originate in manufacturing and assembly processes of the fuel system and accumulate in the filter device, cause damage to the filter structure, for example, cutting the fine-pored filter fabric, so that impurities in the fuel may be introduced into the valve unhindered during further operation and result there in leakage problems and altered functions.

### BRIEF SUMMARY OF THE INVENTION

The valve according to the present invention for metering fluid has the advantage that the provision of a coarse filter and a fine filter situated downstream from it in the flow direction of the fluid increases the robustness of the filter device significantly against larger particles in the fluid, which accumulate in manufacturing and assembly processes of the fluid system. The coarse particles are captured in the significantly more stable coarse filter used as a prefilter and are thus not able to damage the fine-meshed filter structure of the fine filter. This ensures that the smaller particles usually contained in the fluid are reliably captured in the undamaged fine filter and are unable to penetrate into the valve. This largely prevents leakage problems and changes of the functions and the metering precision of the valve and significantly lengthens the service life of the valve.

According to one advantageous specific embodiment of the present invention, the coarse filter and the fine filter are each configured as a filter pot having a pot opening, a closed pot bottom, through which the fluid is unable to flow, a pot casing provided with at least one filter window, and an annular shoulder on the pot opening projecting radially beyond the pot casing, which presses on the channel wall of the flow channel, forming a seal. The at least one filter window of the coarse filter has a coarse-meshed or coarse-pored filter surface and the at least one filter window of the fine filter has a fine-meshed or fine-pored filter surface. In terms of manufacturing, such filter pots may be manufactured in a simple manner as standardized injection molded plastic parts. Alternatively, it is also possible to manufacture only the filter pot by plastic injection molding and inject it onto the filter surfaces made of a metal mesh.

The filter pots may be combined to form the filter device in various ways. Thus, the coarse filter and the fine filter may be situated in the flow channel in such a way that the pot opening of the fine filter faces the pot bottom of the coarse filter and has a clear distance from the pot bottom. Alternatively, the filter pots may be situated in the flow channel in such a way that their pot bottoms or their pot openings face one another. In this case, both the pot bottoms and the pot openings may be directly adjacent to one another or have a clear distance from one another. In all these modifications of the filter device, the fluid flows through the filter surfaces of the coarse filter and the fine filter in sequence.

In one preferred specific embodiment of the present invention, the pot bottoms of the two filter pots are adjacent to one another and are designed to be integrally joined. As a result, the filter device forms a module which is simple to manufacture and advantageous to assemble. The annular shoulders present on both ends of the filter device, which face away from one another, support the filter device in the flow channel in a stable manner and force the fluid to flow in succession through the filter surfaces of the coarse filter and the fine filter.

According to one alternative specific embodiment of the present invention, the two annular shoulders, each enclosing a pot opening, may be adjacent to one another and be designed to be integrally joined. In this case, the filter device is only supported centrally in the flow channel.

The present invention further relates to a filter device to be situated in a flow channel, through which the fluid flows, having a coarse filter and a fine filter which is fixedly connected to it, the fine filter being situated in the predefined flow direction of the filter device downstream from the coarse filter.

According to one advantageous specific embodiment of the filter device, both the coarse filter and the fine filter are formed as a filter pot having a pot opening, a pot bottom, through which the fluid is unable to flow, a pot casing provided with at least one filter window, and an annular shoulder on the pot opening projecting radially beyond the pot casing, producing a tight seal against the flow channel. The pot bottoms of the two filter pots lie adjacent to one another and are designed to be integrally joined. The at least one filter window of the coarse filter has a coarse-meshed or coarse-pored filter surface and the at least one filter window of the fine filter has a fine-meshed or fine-pored filter surface. Such a modular filter device may be manufactured in a cost-effective way and offers advantages for installation in a fluid delivery system.

### BRIEF DESCRIPTION OF THE DRAWINGS

FIG. 1 shows a longitudinal section of a valve for metering fluid including a filter device.

FIG. 2 shows an enlarged representation of the filter device in FIG. 1 in section according to line II-II in FIG. 3.

FIG. 3 shows a section of the filter device along line III-III in FIG. 2.

FIG. 4 shows a perspective representation of the filter device in FIG. 2.

FIG. 5 shows an enlarged representation of detail V in FIG. 1 including a modified filter device.

FIG. 6 shows an identical representation as in FIG. 5 including another modification of the filter device.

FIG. 7 shows an identical representation as in FIG. 5 including a third modification of the filter device.

### DETAILED DESCRIPTION OF THE INVENTION

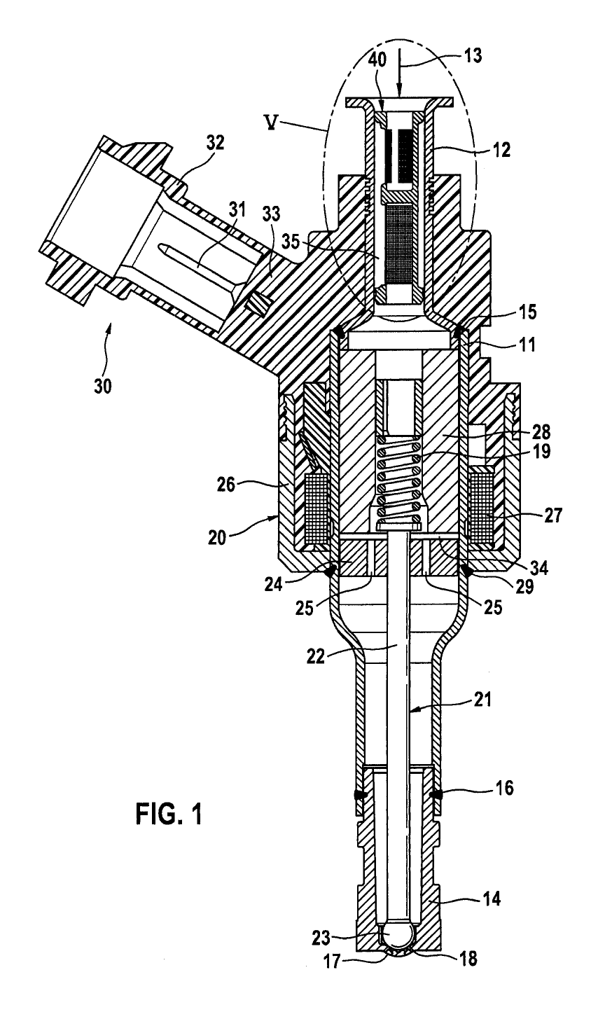

The valve for metering fluid shown in longitudinal section in FIG. 1 is used, for example, in internal combustion engines as an injector for injecting fuel into the intake manifold or the combustion chamber of the internal combustion engine or as a metering valve for metering a urea-water solution into the exhaust pipe of the internal combustion engine. The valve is also used in heating systems operated using heating oil or gas and in gas engines.

The valve for metering fluid shown in longitudinal section in FIG. 1 has a tubular valve housing 11, a connecting piece 12 including a fluid inlet 13 inserted into its one end and a hollow valve-seat carrier 14 inserted into its other end. Connecting piece 12 and valve-seat carrier 14 are integrally joined to valve housing 11. The integral joint is in each case produced by welding as indicated in FIG. 1 by welds 15 and 16. A metering opening 17 and a valve seat 18 enclosing metering opening 17 are formed in valve-seat carrier 14. In the case of use as a fuel injector, metering opening 17 forms a fuel injection aperture which protrudes into the intake manifold or the combustion chamber of the internal combustion engine. A valve member 21 activated by a valve-closure spring 19 and a solenoid 20 has an elongated, solid valve needle 22 and a closing head 23 fixed to the end of valve needle 22 facing metering opening 17, which interacts with valve seat 14 for closing and unblocking metering opening 17. Valve-closure spring 19 acts on the rear side of valve needle 22 which is widened in the form of a flange and faces away from closing head 23, and an armature 24 of solenoid 20 is directly attached to this end of valve needle 22, solenoid 20 having at least one passage bore 25 for the fluid.

In a known manner, solenoid 20 has a magnet pot 26, a solenoid coil 27, made up of a coil support and an excitation coil wound on the coil carrier, and a magnet core 28. With the aid of a recess in the pot bottom, magnet pot 26 is placed on valve housing 11 and is welded to valve housing 11 on the pot bottom, as is indicated by weld 29. Solenoid coil 27 including its coil carrier accommodated in magnet pot 26 is placed directly on valve housing 11, and the excitation winding of solenoid coil 27 is connected to contact pins 31 of an electrical plug connector 30. In this case, contact pins 31 are accommodated in a connector housing 32, which is formed as a plastic extrusion coating 33. Plastic extrusion coating 33 is extruded on one part of connecting piece 12 and on one part of valve housing 11; it partially reaches over magnet pot 26 and fills the interior of magnet pot 26 around solenoid coil 27. In the area of magnet pot 26, hollow magnet core 28 is fixed coaxially in valve housing 11, and with the aid of its one face together with the face of armature 24, it encloses a working air gap 34 of solenoid 30.

A flow channel 35 running from fluid inlet 13 to metering opening 17 is present in the valve, the channel walls of the flow channel being formed in different channel sections from connecting piece 12, magnet core 28, armature 24 including passage bores 25, valve housing 11 and valve-seat carrier 14. To prevent foreign particles and other mechanical impurities from penetrating into the valve, a filter device 40 is provided, which is situated in the inlet area in flow channel 35 close to fluid inlet 13, in this case lying axially non-displaceably in connecting piece 12. Filter device 40 has a coarse filter 41 and a fine filter 42, which is situated downstream from coarse filter 41 in the flow direction of the fluid.

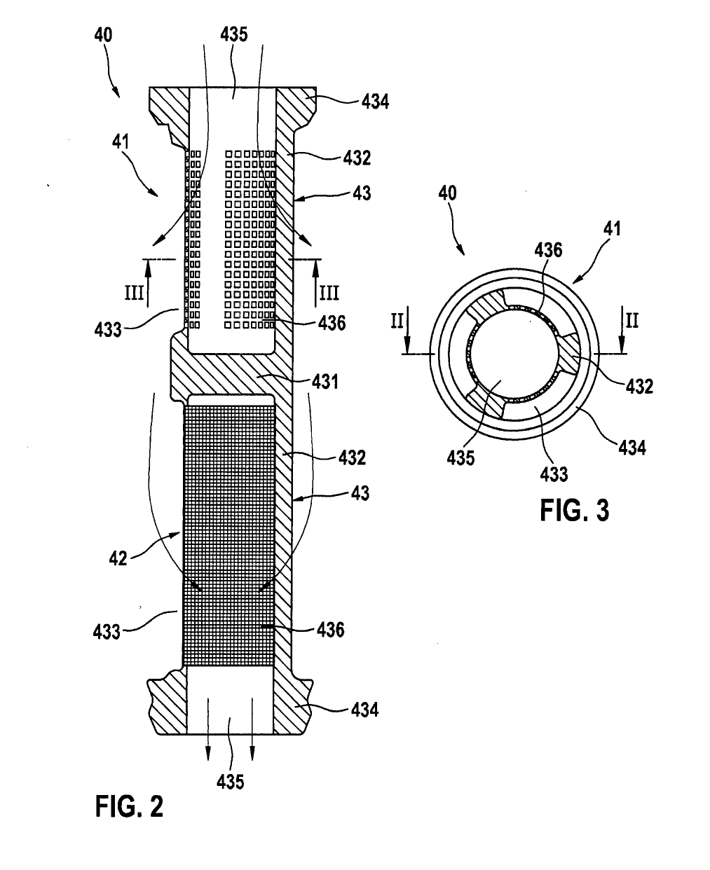

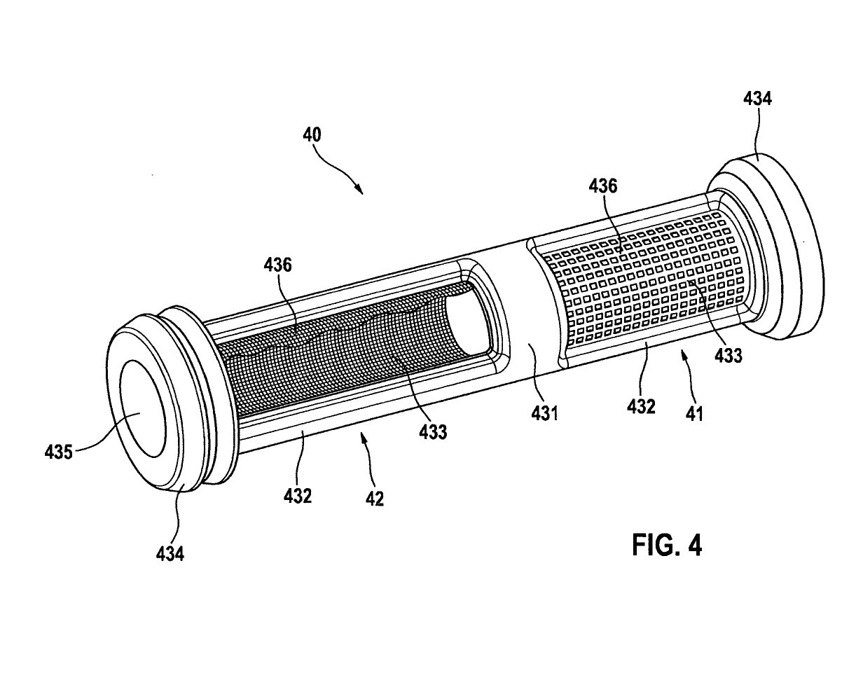

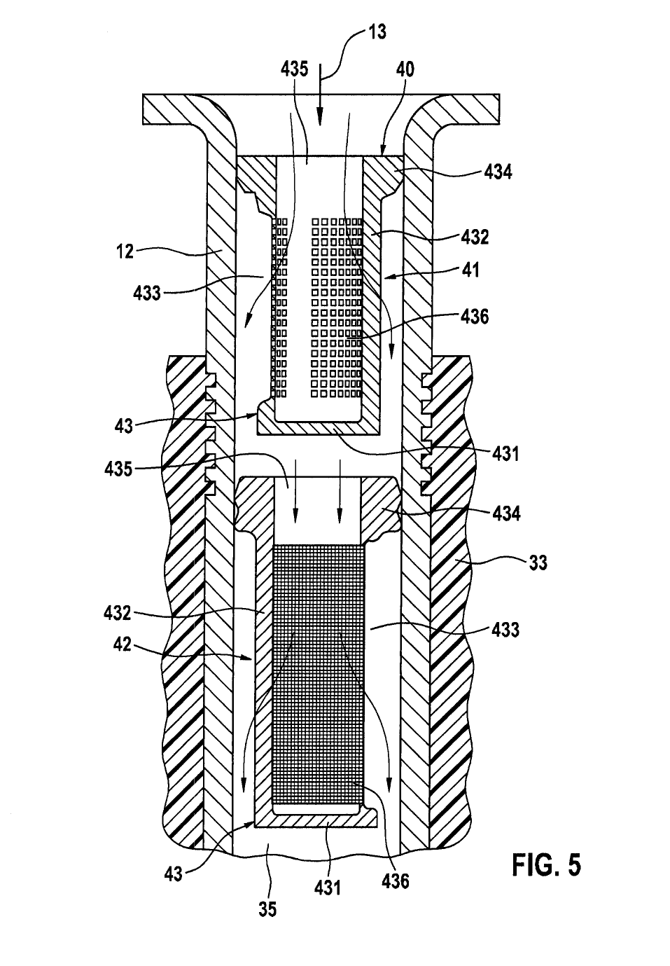

In the exemplary embodiment of FIG. 1, filter device 40, including coarse filter 41 and fine filter 42, is a modular unit, as shown in FIG. 2 in enlarged section and in FIG. 4 in a perspective view. In contrast, in the exemplary embodiments of FIGS. 5 through 7, coarse filter 41 and fine filter 42 are separated structural components, which are situated in flow channel 35 one after another in different orientation.

Each filter 41, 42 is designed as a filter pot 43. Each filter pot 43 has a pot opening 435, a closed, fluid-impermeable pot bottom 431, a pot casing 432, which is provided with at least one filter window 433, and an annular shoulder 434 projecting radially beyond pot casing 432, which encloses pot opening 435 and presses on the channel wall of flow channel 35 to form a seal. Filter window 433 is understood in this case to be an opening held available in pot casing 432, covered by a filter surface. The at least one filter window 433 of coarse filter 41 has a coarse-meshed or coarse-pored filter surface 436, and the at least one filter window 433 of fine filter 42 has a fine-meshed or fine-pored filter surface 436. In the exemplary embodiments of filter device 40 shown, three filter windows 433, which are offset from one another by 120°, are present in pot casing 432, as is evident from the sectional drawing according to FIG. 3. Filter surfaces 436 are situated on the inside of filter window 433 facing the pot center and are fixed to pot casing 432. In the perspective representation of filter device 40 according to FIG. 4, filter surface 436 of the one filter window 433 in fine filter 42 is partially cut away. Filter surfaces 436 are, for example, implemented with the aid of a filter fabric, a filter grid or a filter screen.

In the exemplary embodiment of FIG. 1, pot bottoms 431 of the two filter pots 43 lie adjacent to one another and are designed to be integrally joined. Such a modular filter device 40 may be manufactured in a simple manner, for example, as a single-piece injection molded plastic part, and may be assembled in a cost-saving manner by simple insertion into connecting piece 12, the two annular shoulders 434 present on both ends of filter device 40, which face away from one another, pressing on the inside of connecting piece 12, forming a seal, and thus ensuring the flow of fluid through coarse filter 41 and the downstream flow of fluid through fine filter 42. The two annular shoulders 434 situated at the greatest possible distance from one another also result in a stable seat of filter device 40 in connecting piece 12.

Alternatively, it is also possible to situate filter pots 43 of modular filter device 40 in such a way that the two pot openings 435 face one another and annular shoulders 434 enclosing pot openings 435 are adjacent to one another and are designed to be integrally joined. In this case, only central, single annular shoulder 435 of modular filter device 40 is in contact with the inside of connecting piece 12, forming a seal, so that the fluid flows in through filter surfaces 436 of coarse filter 41, flows through pot openings 435 of coarse and fine filters 41, 42, and exits again into flow channel 35 via filter surfaces 436 of fine filter 42. Such a modular filter device 40 may also be manufactured by plastic injection molding. In principle, filter surfaces 436 may also be made from metal mesh, for example, a metal mesh cylinder, and filter pots 43 including pot bottom 431, pot casing 432 and annular shoulder 434 may be injected onto the metal mesh.

In the exemplary embodiments of filter device 40 according to FIGS. 5 through 7, coarse filter 41 and fine filter 42 are designed as separate structural components which result in filter device 40 after being inserted into flow channel 35. The two filters 41, 42 are again formed as filter pots 43, as described above. In all three exemplary embodiments, filter pots 43 are inserted into flow channel 35 in such a way that the fluid flows through the two filters 41, 42 in the sequence coarse filter 41 and fine filter 42. The forced conveyance of the fluid is determined by annular shoulders 434, which are in contact with the channel wall of flow channel 35 to form a seal and enclose pot openings 435. The exemplary embodiments of filter device 40 in FIGS. 5 through 7 differ exclusively in the orientation of the two filter pots 43 in flow channel 35.

In the exemplary embodiment of FIG. 5, the two filter pots 43 are situated in the same orientation with a clear distance from one another, so that pot opening 435 of fine filter 42 faces pot bottom 431 of coarse filter 41 and is at a distance from it. In the case of the two filters 41, 42, the fluid flows in via pot openings 435 and out again via filter surfaces 436.

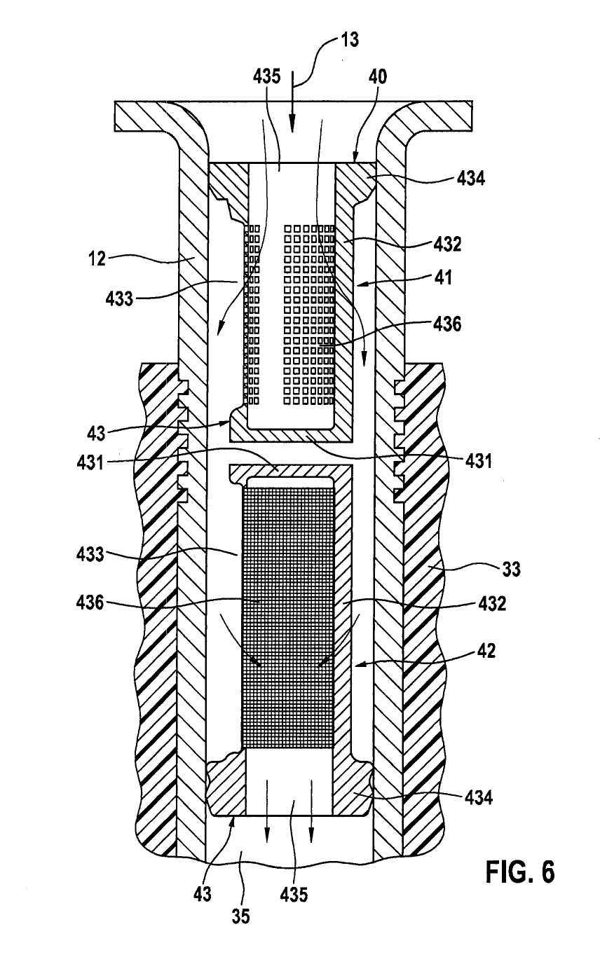

In the exemplary embodiment of FIG. 6, filter pot 43 of fine filter 42 is inserted into flow channel 35 rotated by 180°, so that pot bottoms 431 of coarse filter 41 and fine filter 42 face one another and are spaced apart from one another. This arrangement is consistent with modular filter device 40 according to FIGS. 1 through 4, except that pot bottoms 431 are not connected to one another but instead are spaced apart from one another. Both pot bottoms 431 may also be directly adjacent to one another.

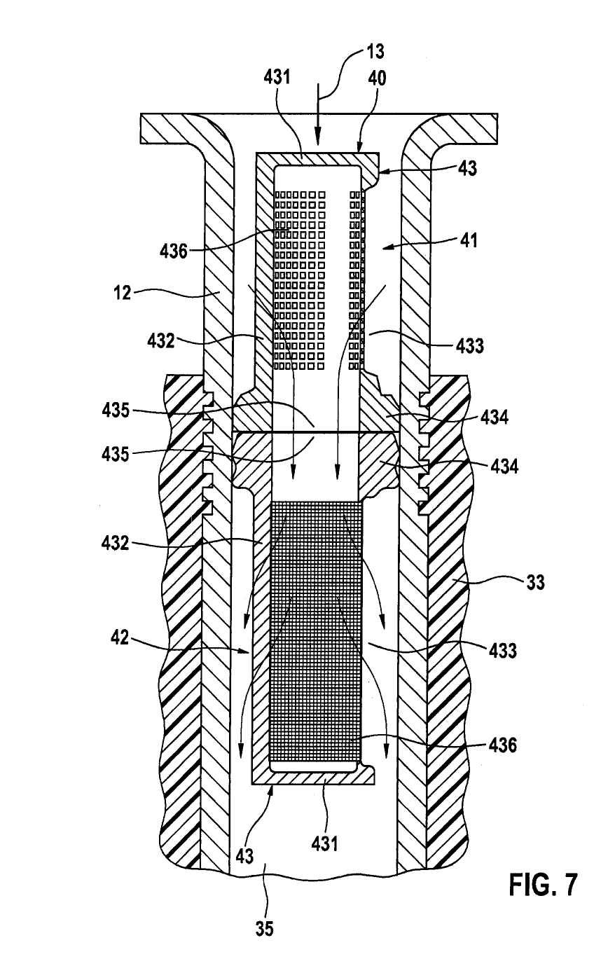

In the exemplary embodiment of the filter device according to FIG. 7, filter pots 43 of coarse filter 41 and fine filter 42 are inserted into flow channel 35 in such a way that pot openings 435 face one another and the faces of annular shoulders 434 are directly adjacent to one another. Alternatively, both annular shoulders 434 may also be spaced apart from one another axially. The fluid flows in via filter surfaces 436 of coarse filter 41, flows through the two pot openings 435 and exits filter device 40 again via filter surfaces 436 of fine filter 42.

1-13. (canceled)

14. A valve for metering fluid, comprising:
a flow channel which leads from a fluid inlet to a metering opening for the fluid; and
a filter device situated in the flow channel, wherein the fluid flows through the filter device and the flow channel, and wherein the filter device has a coarse filter and a fine filter situated downstream from the coarse filter in the flow direction.

15. The valve as recited in claim 14, wherein the coarse filter and the fine filter are each configured as a filter pot which has (i) a pot opening, (ii) a fluid-impermeable pot bottom, (iii) a pot casing provided with at least one filter window, and (iv) an annular shoulder projecting radially beyond the pot casing on the pot opening, the annular shoulder pressing on the channel wall of the flow channel to form a seal, and wherein the at least one filter window of the coarse filter has one of a coarse-meshed or coarse-pored filter surface and the at least one filter window of the fine filter has one of a fine-meshed or fine-pored filter surface.

16. The valve as recited in claim 15, wherein each pot casing has three filter windows, each of which is offset from one another by 120°, and wherein the filter surfaces are fixed to the inner surface of the pot casing facing the pot center.

17. The valve as recited in claim 15, wherein the filter pots of the coarse filter and the filter pots of the fine filter are situated in the flow channel in such a way that the pot opening of the fine filter faces the pot bottom of the coarse filter and is at a defined distance from the pot bottom.

18. The valve as recited in claim 15, wherein the filter pots of the coarse filter and the filter pots of the fine filter are situated in the flow channel in such a way that one of:
(i) the pot bottoms of the coarse filter and the fine filter face one another and are one of at a defined distance from one another or directly adjacent to one another; or
(ii) the pot openings of the coarse filter and the fine filter face one another and are one of at a defined distance from one another or directly adjacent to one another.

19. The valve as recited in claim 18, wherein one of:
(i) the pot bottoms of the coarse filter and the fine filter face one another and are directly adjacent to one another, wherein the pot bottoms of the coarse filter and the fine filter are integrally joined; or
(ii) the annular shoulders enclosing the pot openings of the coarse filter and the fine filter which face one another and are directly adjacent to one another are integrally joined.

20. The valve as recited in claim 15, wherein the filter pots including filter surfaces are manufactured by plastic injection molding.

21. The valve as recited in claim 15, wherein the filter pots are manufactured as injection molded plastic parts and the filter surfaces are made of metal mesh.

22. A filter device to be situated in a flow channel through which fluid flows, the filter device comprising:
a coarse filter; and
a fine filter fixedly connected to the coarse filter and situated downstream from the coarse filter in the flow direction.

23. The filter device as recited in claim 22, wherein:
the coarse filter and the fine filter are each configured as a filter pot which has (i) a pot opening, (ii) a fluid-impermeable pot bottom, (iii) a pot casing provided with at least one filter window, and (iv) an annular shoulder projecting radially beyond the pot casing on the pot opening, the annular shoulder pressing on the channel wall of the flow channel to form a seal;
the pot bottoms of the coarse filter and the fine filter are directly adjacent to one another and integrally joined; and
the at least one filter window of the coarse filter has one of a coarse-meshed or coarse-pored filter surface and the at least one filter window of the fine filter has one of a fine-meshed or fine-pored filter surface.

24. The filter device as recited in claim 23, wherein the filter pots including filter surfaces are manufactured as modular plastic injection molded parts.

25. The filter device as recited in claim 23, wherein the filter pots are manufactured as modular plastic injection molded parts, and the filter surfaces are made of a metal mesh or grid, onto which the injection molded part is injected.

26. The filter device as recited in claim 23, wherein the flow channel is a connection element between a fuel injection opening and a fuel inlet of a fuel injection system in an internal combustion engine.
